(19) United States
(12) Patent Application Publication
(10) Pub. No.: US 2004/0034585 A1
(43) Pub. Date: Feb. 19, 2004

(54) Charitable donation system integrated with brokerage account

(76) Inventor: James A. Saunders, Phoenix, AZ (US)

Correspondence Address: BROOKS KUSHMAN P.C., 1000 TOWN CENTER, TWENTY-SECOND FLOOR, SOUTHFIELD, MI, 48075, US

(21) Appl. No.: 10/642,471

(22) Filed: Aug. 14, 2003

Related U.S. Application Data
(60) Provisional application No. 60/403,602, filed on Aug. 14, 2002.

(51) Int. Cl. G06F 17/60

(52) U.S. Cl. 705/35; 705/31

(57) ABSTRACT

A systematic method of making donations to charities from investment income is provided. Mutual fund investors and other investors are provided with an option to designate that a gift to a charity is to be paid from the brokerage account. The gift may be of a fixed amount or of a percentage of investment income, or may be limited to a portion of investment income that is taxed at the highest tax rate for the investor. The mutual fund or investment management entity may receive compensation in the form of an administrative fee that may be a set annual amount or a percentage of gifts made.

### CROSS-REFERENCE TO RELATED APPLICATION

This application claims the benefit of U.S. provisional application Serial No. 60/403,602, filed Aug. 14, 2002, and entitled “Charitable Donation System Integrated With Brokerage Account”.

### BACKGROUND OF THE INVENTION

1. Field of the Invention

One aspect of the present invention relates to a system for donating charitable gifts from a brokerage account.

2. Background Art

Charities rely upon a stream of charitable donations to fund charity activities. Charitable donations are made by donors to their favorite charities through pledges or in response to solicitations from charities, particularly at year end. Donors who are capable of donating large sums of money to charities frequently are relatively high tax bracket taxpayers. Deductions for charitable donations make it possible for such large donors to make sizeable donations with the understanding that the donation can be itemized as a deduction against federal and state taxes.

Some donors prefer making charitable donations from investment income instead of donating from ordinary income such as wages, salaries or profits. Brokerage accounts may include mutual funds, securities such as stocks and bonds, money market funds and hedge funds. Increasingly, investors prefer to invest in mutual fund accounts. Mutual funds are required to maintain detailed records tracking capital loss and gains, dividend distributions and ordinary income.

There is a need for a simple and systematic system for making donations to charity from an investment or a brokerage account. There is also a need for a system that maximizes the tax deduction available for charitable donations. The above problems and needs are addressed by applicant's invention as summarized below.

### SUMMARY OF THE INVENTION

According to the present invention a simple and systematic method of making donations to charities from investment income is provided. Mutual fund investors and other investors are provided with an option to designate that a gift to a charity is to be paid from the brokerage account. The gift may be of a fixed amount or of a percentage of investment income, or may be limited to a portion of investment income that is taxed at the highest tax rate for the investor. The mutual fund or investment management entity may receive compensation in the form of an administrative fee that may be a set annual amount or a percentage of gifts made. Mutual funds, hedge funds and other investment managers regularly track fund transactions for capital losses and capital gains, dividend distributions and the realization of ordinary income. Some of the benefits to investment companies that adopt the system include additional administrative fee income, a potential for increasing the total value of assets under management, and an ability to offer a unique service to investment clients.

Charities benefit from increased and systematic donations while investor can limit donations to taxable profits from investment fund. The ease with which the system can be implemented has the potential to increase the base of donors and promote ongoing contributions. The system facilitates growth of charitable donations by providing a easy to use, simple, tax advantaged strategy for converting taxable income into charitable gifts.

The system utilizes an algorithm that takes donations from investment returns of the higher tax rate income first and then from lower tax rate income investments. The algorithm increases the net after tax yield of the fund incrementally which is an additional advantage for the investment management firm when measuring fund results against competitors. The system also anticipates authorization of gift amounts on a year to year basis to maximize charitable deductions particularly in years when there have been simultaneous fund losses and taxable gains.

The system operates with existing bank or investment house administrative and software infrastructure. The system allows for regular donations to be made directly to charities or through a charitable donation clearinghouse that relieves any administrative burden on the bank or investment company.

According to a first embodiment of the present invention, a computer-implemented method for donating charitable gifts from a brokerage account is disclosed. The method includes receiving brokerage account data of a brokerage account for generating an investment income from a principle amount, the investment income comprising at least one of the following: a first investment income amount subject to a first tax rate and generated from a first principle amount and a second investment income amount subject to a second tax rate and generated from a second principle amount, the first tax rate being higher than the second tax rate; receiving a request to pay a gift amount from the investment income; and transferring at least a portion of the first and/or second investment income to satisfy the gift amount based on a tax-advantaged algorithm, the tax-advantaged algorithm compares the first and second tax rates. The gift amount is transferred to maximize the tax deduction available for the gift amount. The first investment income and the first principle amount can include one or more first shares and the second investment income and the second principle amount can include one or more second shares.

The tax-advantaged algorithm can include the following steps. If the first investment income is available for use as at least a portion of the gift amount, then if the first investment income amount is at least equal to the gift amount, then the tax-advantaged algorithm includes selling at least one of the one or more first shares and transferring at least a portion of the first investment income amount to satisfy the gift amount. If the first investment income amount is less than the gift amount, the tax-advantaged algorithm includes selling at least one of the one or more first shares transferring at least a portion the first investment income amount to satisfy a portion of the gift amount and if the second income is available for use as at least a portion of the gift amount, then selling at least one of the one or more second shares, and if the second investment income amount is at least equal to the unsatisfied gift amount, then selling at least one of the one or more second shares, and transferring at least a portion the second investment income amount to satisfy the unsatisfied gift amount, else selling at least one of the one or more second shares, and transferring at least a portion of the second investment income amount to satisfy a portion of the unsatisfied gift amount, else if the second income is available for use as at least a portion of the gift amount, then if the second investment income amount is at least equal to the gift amount, then selling at least one of the one or more second shares, and transferring at least a portion the second investment income amount to satisfy the gift amount, else selling at least one of the one or more second shares and transferring at least a portion of the second investment income amount to satisfy a portion of the gift amount.

According to a second embodiment of the present invention, a computer-implemented system for donating charitable gifts from a brokerage account is disclosed. The system includes one or more computers and the one or more computers can be configured to: receive brokerage account data of a brokerage account for generating an investment income from a principle amount, the investment income comprising at least one of the following: a first investment income amount subject to a first tax rate and generated from a first principle amount and a second investment income amount subject to a second tax rate and generated from a second principle amount, the first tax rate being higher than the second tax rate; receive a request to pay a gift amount from the investment income; and transfer at least a portion of the first and/or second investment income to satisfy the gift amount based on a tax-advantaged algorithm, the tax-advantaged algorithm compares the first and second tax rates. The gift amount is transferred to maximize the tax deduction available for the gift amount. The first investment income and the first principle amount can include one or more first shares and the second investment income and the second principle amount can include one or more second shares. The tax-advantaged algorithm can include the steps disclosed above as part of the first embodiment.

According to a third embodiment of the present invention, a computer-implemented system for donating charitable gifts from a brokerage account. The system includes a means for receiving brokerage account data of a brokerage account for generating an investment income from a principle amount, the investment income comprising at least one of the following: a first investment income amount subject to a first tax rate and generated from a first principle amount and a second investment income amount subject to a second tax rate and generated from a second principle amount, the first tax rate being higher than the second tax rate; a means for receiving a request to pay a gift amount from the investment income; and a means for transferring at least a portion of the first and/or second investment income to satisfy the gift amount based on a tax-advantaged algorithm, the tax-advantaged algorithm compares the first and second tax rates. The gift amount is transferred to maximize the tax deduction available for the gift amount. The first investment income and the first principle amount can include one or more first shares and the second investment income and the second principle amount can include one or more second shares. The tax-advantaged algorithm can include the steps disclosed above as part of the first embodiment.

The above embodiments and other embodiments, features, and advantages of the present invention are readily apparent from the following detailed description of the best mode for carrying out the invention when considered in conjunction with the accompanying drawings.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may be best understood with reference to the following description, considered in conjunction with the accompanying drawings:

FIGS. 1 and 2 represent a flow chart showing one example for implementing an algorithm for providing a system for making charitable donations from investment accounts.

### DETAILED DESCRIPTION OF EMBODIMENTS OF THE PRESENT INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ the present invention.

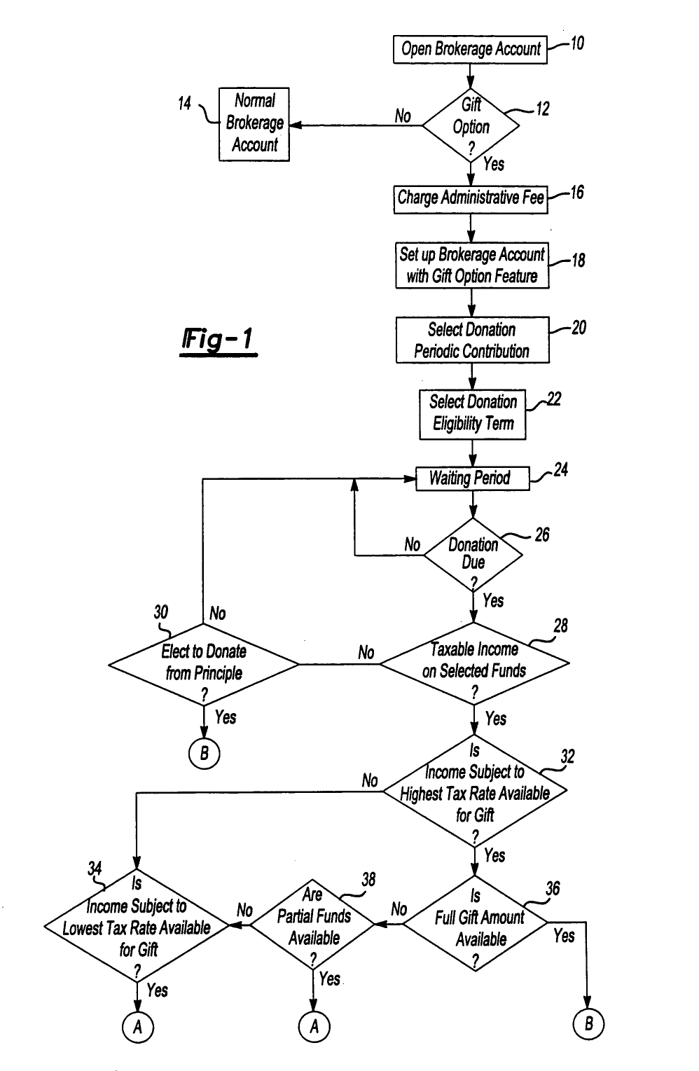

Referring now to FIG. 1, the system may be implemented by initially opening a brokerage account at 10. As part of the brokerage account opening process the brokerage customer is asked if they intend to take advantage of the investment management firm's gift option as part of their brokerage account at 12. If the customer declines the gift option at 12 a normal brokerage account is opened at 14. If the client agrees to the gift option the investment company will charge a small administrative fee at 16, for example $30.00 per year. It should be understood that the administrative fee could be charged at a different point in the process.

The brokerage account is set up with the gift option feature at 18. The customer is asked at 20 to select a donation contribution period and is asked at 22 to select a donation eligibility term. After the brokerage account with the gift option is set up, a waiting period of a predetermined period of time, such as a month, passes at 24. The system inquires at 26 as to whether a donation is due to be made by the donor to the charity. For example, if the waiting period is one month, at the end of each month the system will check the account set up information and if the customer has indicated that a donation should be made at the end of that month. If the account is set up for a quarterly donation every third month the system would continue with the donation process.

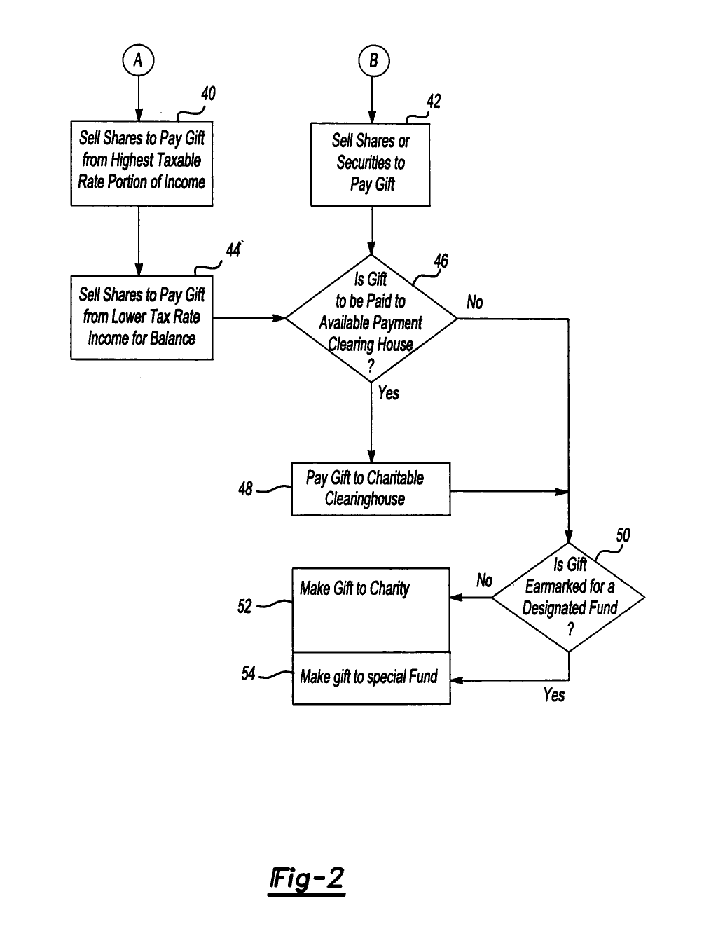

If a donation is due, the system at 26 inquires as to whether there is taxable income in the account on selected funds that are designated in the gift option brokerage account. If there is no taxable income on the selected funds a further query may be made either to the investor or to standing instructions that are part of the gift option brokerage account as to donating to the charity from principle at 30. If not, the system returns to the waiting period at 24. If so, steps will be taken to make a donation as described below. If there is taxable income on the selected funds the system determines whether the available income is subject to the highest tax rate at 32. If not, the system determines if income that is subject to a lower tax rate is available for gift purposes at 34. If income subject to the highest tax rate is available, the system determines whether or not the full gift amount is available at 36. If not, the system determines if partial funds are available from the higher tax rate income. If not, the system determines if funds are available for the gift from lower tax rate income. Referring now to FIG. 2, if so, shares are sold at 40 to pay the gift from the highest tax rate portion of income. Then shares are sold to pay the gift from the lower tax rate income for the balance at 44. If the full gift amount is determined to be available at 36, an instruction is given to sell shares or securities to pay the gift at 42.

After the shares or securities are sold the system determines if the gift is to be paid to a charitable payment clearing house at 46. A charitable payment clearing house would be an agency that coordinates charitable donation payments from many different donors and pays the donations to many different charities according to instructions from each of the individual donors. The charitable payment clearing house is intended to relieve the investment manager from a burden associated with offering the charitable gift system. The charitable payment clearing house could be compensated by the investment management company or by separate fee charged to the donors or charitable organizations. If it is determined that the gift is to be paid to the charitable payment clearing house, the payment is received at 48 and then is transferred by electronic funds transfer to the charity in accordance with the donors instructions. Some charities provide for donor designation of earmarked gifts. If the gift is not earmarked for a designated fund, the gift is given to the charity as a general gift at 52. If the gift is determined to have been earmarked for a designated fund at 50, the system makes the gift to the designated fund at 54.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A computer-implemented method for donating charitable gifts from a brokerage account, the method comprising:
receiving brokerage account data of a brokerage account for generating an investment income from a principle amount, the investment income comprising at least one of the following: a first investment income amount subject to a first tax rate and generated from a first principle amount and a second investment income amount subject to a second tax rate and generated from a second principle amount, the first tax rate being higher than the second tax rate;
receiving a request to pay a gift amount from the investment income; and
transferring at least a portion of the first and/or second investment income to satisfy the gift amount based on a tax-advantaged algorithm, the tax-advantaged algorithm compares the first and second tax rates,
whereby the gift amount is transferred to maximize the tax deduction available for the gift amount.

2. The computer-implemented method of claim 1 wherein the first investment income and the first principle amount is comprised of one or more first shares and the second investment income and the second principle amount is comprised of one or more second shares.

3. The computer-implemented method of claim 2 wherein the tax-advantaged algorithm is comprised of the following steps:
if the first investment income is available for use as at least a portion of the gift amount, then if the first investment income amount is at least equal to the gift amount, then
selling at least one of the one or more first shares;
transferring at least a portion of the first investment income amount to satisfy the gift amount, else
selling at least one of the one or more first shares;
transferring at least a portion the first investment income amount to satisfy a portion of the gift amount and if the second income is available for use as at least a portion of the gift amount, then
selling at least one of the one or more second shares; and
if the second investment income amount is at least equal to the unsatisfied gift amount, then
selling at least one of the one or more second shares; and
transferring at least a portion the second investment income amount to satisfy the unsatisfied gift amount, else
selling at least one of the one or more second shares; and
transferring at least a portion of the second investment income amount to satisfy a portion of the unsatisfied gift amount,
else if the second income is available for use as at least a portion of the gift amount, then
if the second investment income amount is at least equal to the gift amount, then
selling at least one of the one or more second shares; and
transferring at least a portion the second investment income amount to satisfy the gift amount, else
selling at least one of the one or more second shares; and
transferring at least a portion of the second investment income amount to satisfy a portion of the gift amount.

4. A computer-implemented system for donating charitable gifts from a brokerage account, the system comprising one or more computers, the one or more computers configured to:
receive brokerage account data of a brokerage account for generating an investment income from a principle amount, the investment income comprising at least one of the following: a first investment income amount subject to a first tax rate and generated from a first principle amount and a second investment income amount subject to a second tax rate and generated from a second principle amount, the first tax rate being higher than the second tax rate;
receive a request to pay a gift amount from the investment income; and
transfer at least a portion of the first and/or second investment income to satisfy the gift amount based on a tax-advantaged algorithm, the tax-advantaged algorithm compares the first and second tax rates,
whereby the gift amount is transferred to maximize the tax deduction available for the gift amount.

5. The computer-implemented system of claim 4 wherein the first investment income and the first principle amount is comprised of one or more first shares and the second investment income and the second principle amount is comprised of one or more second shares.

6. The computer-implemented system of claim 5 wherein the tax-advantaged algorithm is comprised of the following steps:
if the first investment income is available for use as at least a portion of the gift amount, then if the first investment income amount is at least equal to the gift amount, then
selling at least one of the one or more first shares;
transferring at least a portion of the first investment income amount to satisfy the gift amount, else
selling at least one of the one or more first shares;
transferring at least a portion the first investment income amount to satisfy a portion of the gift amount and if the second income is available for use as at least a portion of the gift amount, then
selling at least one of the one or more second shares; and
if the second investment income amount is at least equal to the unsatisfied gift amount, then
selling at least one of the one or more second shares; and
transferring at least a portion the second investment income amount to satisfy the unsatisfied gift amount, else
selling at least one of the one or more second shares; and
transferring at least a portion of the second investment income amount to satisfy a portion of the unsatisfied gift amount,
else if the second income is available for use as at least a portion of the gift amount, then
if the second investment income amount is at least equal to the gift amount, then
selling at least one of the one or more second shares; and
transferring at least a portion the second investment income amount to satisfy the gift amount, else
selling at least one of the one or more second shares; and
transferring at least a portion of the second investment income amount to satisfy a portion of the gift amount.

7. A computer-implemented system for donating charitable gifts from a brokerage account, the system comprising:
a means for receiving brokerage account data of a brokerage account for generating an investment income from a principle amount, the investment income comprising at least one of the following: a first investment income amount subject to a first tax rate and generated from a first principle amount and a second investment income amount subject to a second tax rate and generated from a second principle amount, the first tax rate being higher than the second tax rate;
a means for receiving a request to pay a gift amount from the investment income; and
a means for transferring at least a portion of the first and/or second investment income to satisfy the gift amount based on a tax-advantaged algorithm, the tax-advantaged algorithm compares the first and second tax rates,
whereby the gift amount is transferred to maximize the tax deduction available for the gift amount.

8. The computer-implemented system of claim 7 wherein the first investment income and the first principle amount is comprised of one or more first shares and the second investment income and the second principle amount is comprised of one or more second shares.

9. The computer-implemented system of claim 8 wherein the tax-advantaged algorithm is comprised of the following steps:
if the first investment income is available for use as at least a portion of the gift amount, then if the first investment income amount is at least equal to the gift amount, then
selling at least one of the one or more first shares;
transferring at least a portion of the first investment income amount to satisfy the gift amount, else
selling at least one of the one or more first shares;
transferring at least a portion the first investment income amount to satisfy a portion of the gift amount and if the second income is available for use as at least a portion of the gift amount, then
selling at least one of the one or more second shares; and
if the second investment income amount is at least equal to the unsatisfied gift amount, then
selling at least one of the one or more second shares; and
transferring at least a portion the second investment income amount to satisfy the unsatisfied gift amount, else
selling at least one of the one or more second shares; and
transferring at least a portion of the second investment income amount to satisfy a portion of the unsatisfied gift amount,
else if the second income is available for use as at least a portion of the gift amount, then
if the second investment income amount is at least equal to the gift amount, then
selling at least one of the one or more second shares; and
transferring at least a portion the second investment income amount to satisfy the gift amount, else
selling at least one of the one or more second shares; and
transferring at least a portion of the second investment income amount to satisfy a portion of the gift amount.
